(19) United States
(12) Patent Application Publication
(10) Pub. No.: US 2021/0264673 A1
(43) Pub. Date: Aug. 26, 2021

(54) ELECTRONIC DEVICE FOR LOCATION-BASED AR LINKING OF OBJECT-BASED AUGMENTATION CONTENTS AND OPERATING METHOD THEREOF

(71) Applicant: NAVER LABS CORPORATION, Seongnam-si (KR)

(72) Inventor: Jeanie JUNG, Seongnam-si (KR)

(73) Assignee: NAVER LABS CORPORATION, Seongnam-si (KR)

(21) Appl. No.: 17/158,440

(22) Filed: Jan. 26, 2021

(30) Foreign Application Priority Data
Feb. 26, 2020 (KR) 10-2020-0023676

(51) Int. Cl. G06T 19/00; H04W 4/029

(52) U.S. Cl. CPC G06T 19/006; H04W 4/029

(57) ABSTRACT

Disclosed are an electronic device and an operating method of the electronic device, which relate to location-based augmented reality (AR) linkage of object-based augmentation content, and may recognize an object based on an image being captured, detect a preset location in association with at least one of the object and the image, determine augmentation content based on the object and the location, and output the augmentation content in correspondence to the object while displaying the image.

### CROSS-REFERENCE TO RELATED APPLICATION(S)

This U.S. non-provisional application and claims the benefit of priority under 35 U.S.C. § 119 to Korean Patent Application No. 10-2020-0023676, filed on Feb. 26, 2020, the entire contents of which are incorporated herein by reference.

### TECHNICAL FIELD

At least one example embodiment relates to an electronic device for location-based augmented reality (AR) linkage of object-based augmentation content and an operating method of the electronic device.

### RELATED ART

With developments in technology, electronic devices perform various functions and provides various services. Currently, electronic devices provide augmented reality (AR). AR refers to technology for the display of virtual augmentation content overlapping a real environment. That is, a user may view the augmentation content corresponding to the real environment through an electronic device. Here, the electronic device simply provides the augmentation content based on only one of an object or a location of the real environment. Accordingly, the electronic device may not provide various AR services to the user.

### SUMMARY

At least one example embodiment provides an electronic device that may provide an experience, marketing, and/or a service, further micro-targeted for a user, and interactive with a space and/or a thing, through linkage between locations of a real environment and an object, and an operating method of the electronic device.

At least one example embodiment provides an electronic device for augmented reality (AR) linkage of object-based augmentation content and an operating method of the electronic device.

According to an aspect of at least one example embodiment, there is provided an operating method of an electronic device, the method including recognizing an object based on a current image being captured, detecting a location in association with at least one of the object or the current image, determining augmentation content based on the object and the location, and generating an augmented reality image including the current image and the augmentation content in correspondence to the object.

According to an aspect of at least one example embodiment, there is provided an electronic device including processing circuitry configured to cause the electronic device to recognize an object based on a current image being captured, detect a location in association with at least one of the object or the current image, determine augmentation content based on the object and the location, and generate an augmented reality image including the current image and the augmentation content in correspondence to the object.

According to an aspect of at least one example embodiment, there is provided a non-transitory computer-readable record medium storing instructions that, when executed by processing circuitry, cause the processing circuitry to perform an operating method of an electronic device, the method including recognizing an object based on a current image being captured, detecting a location in association with at least one of the object or the current image, determining augmentation content based on the object and the location, and generating an augmented reality image including the current image and the augmentation content in correspondence to the object.

According to at least one example embodiment, an electronic device may output augmentation content based on locations of a real environment and an object to provide augmented reality. Here, since the object has a mobility in the real environment, the electronic device may output the augmentation content in correspondence to the object in various situations, for example, at various locations. The electronic device may determine the augmentation content by associating the object with a preset or alternatively, given location. Here, the electronic device may modify the augmentation content about the object through interaction with a peripheral environment. Through this, the electronic device may appropriately output the augmentation content based on various situations. That is, the electronic device may provide a flexible interface between the electronic device and the user to provide the augmented reality. Accordingly, the electronic device may provide an experience, marketing, and a service, further micro-targeted for the user and interactive with a space and a thing, by providing the augmentation content through linkage between locations of the real environment and the object.

For example, the electronic device may provide an AR mask for an object (e.g., a face of a recognized person) as augmentation content. Here, if the person is present at a specific location, the electronic device may provide an interaction between augmentation content about the specific location and augmentation content about the face. For example, the electronic device may output a make-up mask corresponding to the face of the recognized person. In response to the person being located at a cosmetic shop of the specific location, the electronic device may change a lipstick color of the make-up mask with a color preset or alternatively, given for the specific location or may apply, to the make-up mask, an additional make-up function preset or alternatively, given for the specific location.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of an electronic device according to at least one example embodiment;

FIGS. 2A, 2B, 2C, 2D, 2E, and 2F illustrate examples of an operation of an electronic device according to at least one example embodiment;

FIG. 3 is a flowchart illustrating an example of an operating method of an electronic device according to at least one example embodiment;

FIG. 4A is a flowchart illustrating an example of an augmentation content determining operation of an electronic device according to at least one example embodiment;

FIG. 4B is a flowchart illustrating another example of an augmentation content determining operation of an electronic device according to at least one example embodiment;

FIG. 5A is a flowchart illustrating an example of an augmentation content outputting operation of an electronic device according to at least one example embodiment; and

FIG. 5B is a flowchart illustrating another example of an augmentation content outputting operation of an electronic device according to at least one example embodiment.

### DETAILED DESCRIPTION

At least one example embodiment will be described in detail with reference to the accompanying drawings. At least one example embodiment, however, may be embodied in various different forms, and should not be construed as being limited to only the illustrated examples. Rather, the illustrated examples are provided so that this disclosure will be thorough and complete, and will fully convey the concepts of this disclosure to those skilled in the art. Accordingly, known processes, elements, and techniques, may not be described with respect to at least one example embodiment. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as, or a similar meaning to, that commonly understood by one of ordinary skill in the art to which at least one example embodiment belongs. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned herein. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, at least one example embodiment may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of at least one example embodiment may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, at least one example embodiment will be described with reference to the accompanying drawings.

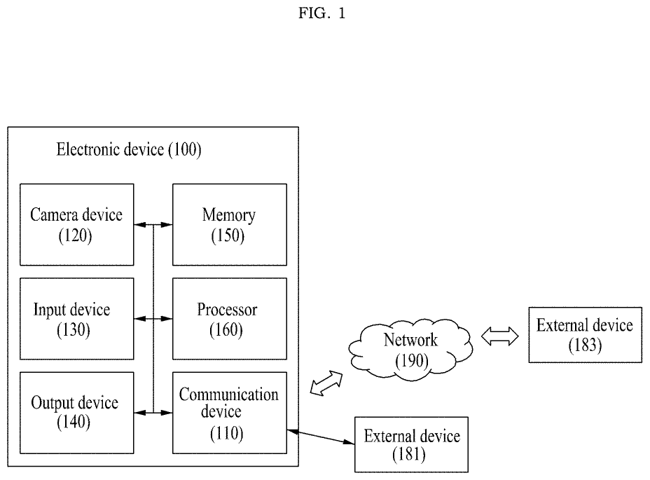

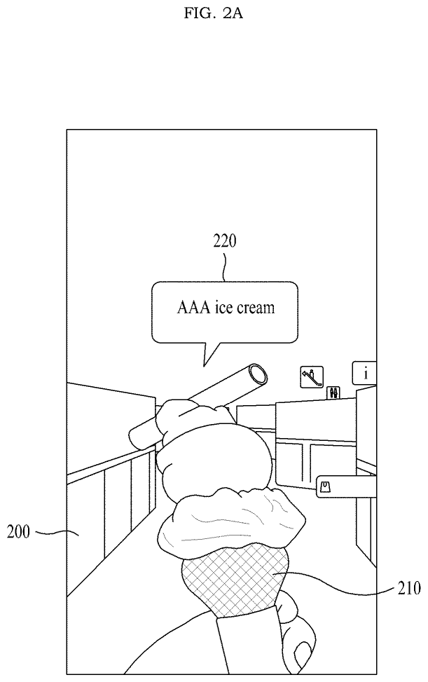

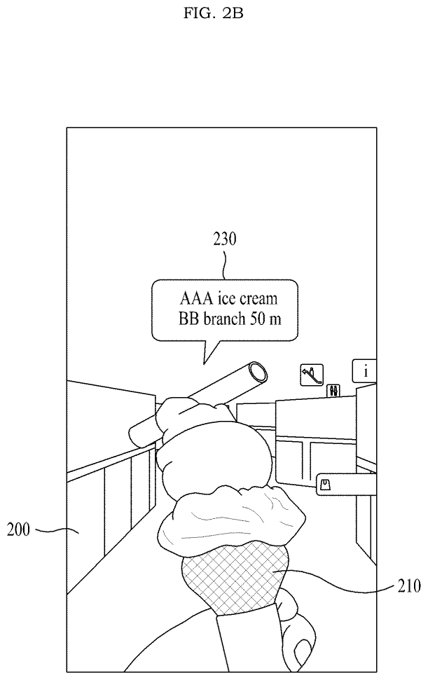

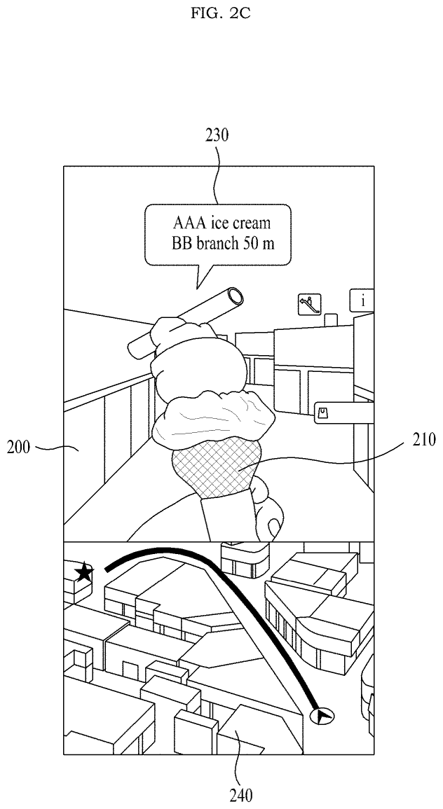

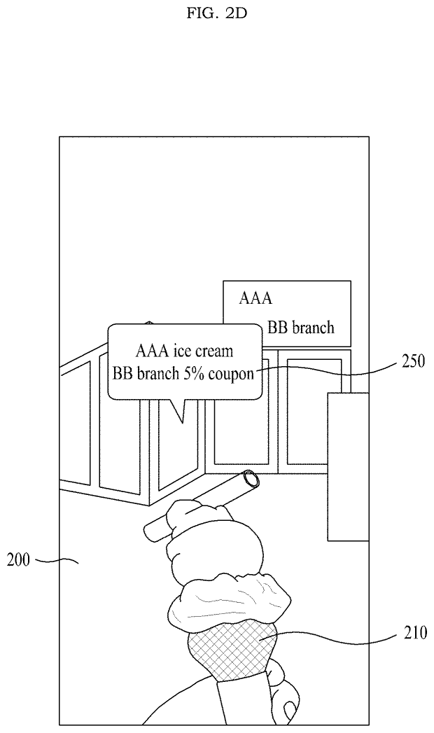

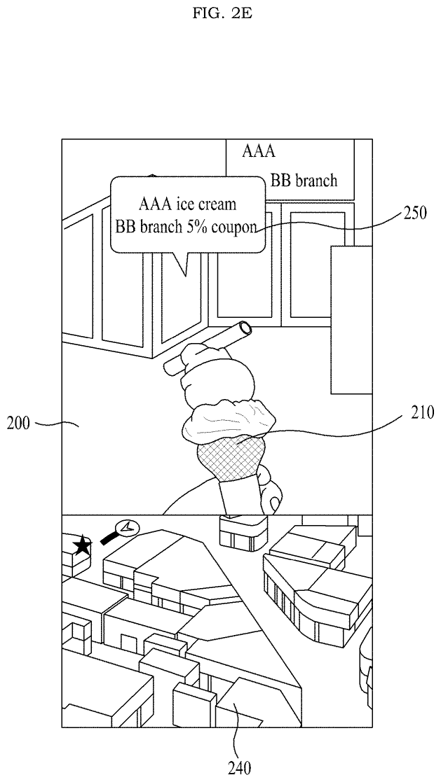

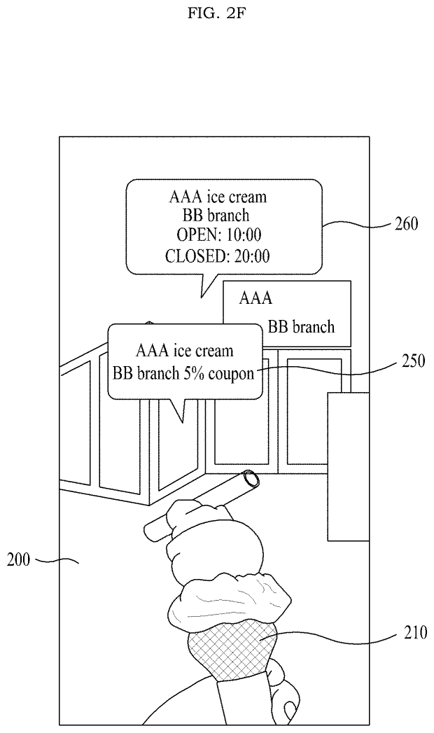

FIG. 1 is a diagram illustrating an electronic device 100 according to at least one example embodiment. FIGS. 2A, 2B, 2C, 2D, 2E, and 2F illustrate examples of an operation of the electronic device 100 according to at least one example embodiment.

Referring to FIG. 1, the electronic device 100 according to at least one example embodiment may include at least one of a communication device 110, a camera 120, an input device 130, an output device 140, a memory 150, and/or a processor 160 (also referred to herein as components of the electronic device 100).

Depending on at least one example embodiment, at least one component may be omitted from among components of the electronic device 100 and at least one another component may be added thereto. Depending on at least one example embodiment, at least two of the components of the electronic device 100 may be configured as a single integrated circuit. For example, the electronic device 100 may include at least one of a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a robot, etc.

The communication device 110 may enable the electronic device 100 to communicate with an external device 181, 183 (e.g., the external device 181 and/or the external device 183). The communication device 110 may allow the electronic device 100 to establish a communication channel with the external device 181, 183 and to communicate with the external device 181, 183 through the communication channel. Here, the external device 181, 183 may include at least one of a satellite, a base station, a server, and/or one or more other electronic devices. The communication device 110 may include at least one of a wired communication device and/or a wireless communication device. The wired communication device may be connected to the external device 181 in a wired manner and may communicate with the external device 181 in the wired manner. The wireless communication device may include at least one of a near field communication device and/or a far field communication device. The near field communication device may communicate with the external device 181 using a near field communication method. For example, the near field communication method may include at least one of Bluetooth, wireless fidelity (WiFi) direct, and/or infrared data association (IrDA). The far field communication device may communicate with the external device 183 using a far field communication method. Here, the far field communication device may communicate with the external device 183 over a network 190 (e.g., via a base station, access point, etc.). For example, the network 190 may include at least one of a cellular network, the Internet, and/or a computer network such as a local area network (LAN) and/or a wide area network (WAN).

The camera 120 may capture an image in the electronic device 100. Here, the camera 120 may be installed at a preset or alternatively, given location of the electronic device 100, and may capture the image. Also, the camera 120 may create image data. For example, the camera 120 may include at least one of at least one lens, an image sensor, an image signal processor, and/or a flash.

The input device 130 may input a signal to be used for at least one component of the electronic device 100. The input device 130 be configured for the user to directly input an instruction or a signal to the electronic device 100, and/or a sensor device configured to detect an ambient environment and to create a signal. For example, the input device may include at least one of a microphone, a mouse, and/or a keyboard. Depending on at least one example embodiment, the sensor device may include at least one of a touch circuitry configured to detect a touch, and/or a sensor circuitry configured to measure the strength of a force occurring due to the touch.

The output device 140 may output information to an outside of the electronic device 100. The output device 140 may include at least one of a display device configured to visually output information, and/or an audio output device configured to output information as an audio signal. For example, the display device may include at least one of a display, a hologram device, and/or a projector. For example, the display device may be configured as a touchscreen through assembly (e.g., connection) to at least one of the sensor circuitry and/or the touch circuitry of the input device 130. For example, the audio output device may include at least one of a speaker and/or a receiver.

The memory 150 may store a variety of data used by at least one component of the electronic device 100. For example, the memory 150 may include at least one of a volatile memory and/or a non-volatile memory. Data may include at least one program, and/or input data and/or output data related thereto. The program may be stored in the memory 150 as software including at least one instruction and may include at least one of an OS, middleware, and/or an application.

The processor 160 may control at least one component of the electronic device 100 by executing the program of (e.g., stored in) the memory 150. Through this, the processor 160 may perform data processing or an operation. Here, the processor 160 may execute an instruction stored in the memory 150.

The processor 160 may track an object based on an image captured through the camera 120. To this end, the processor 160 may recognize the object based on the image captured through the camera 120. According to at least one example embodiment, an object may be fixed at a preset or alternatively, given location and may be moved to another location by an administrator. For example, the object may include a structure in a specific shape, such as a signboard, a column, a wall, and/or a sculpture. According to at least one example embodiment, the object may be carried and/or moved by the user of the electronic device 100. For example, the object may include a product in a specific shape, such as a doll and/or an ice cream. According to another example, the object may be moved through autonomous driving. For example, the object may include a moving object in a specific shape, such as a robot. Here, information about at least one object may be prestored or stored in the memory 150. The processor 160 may recognize at least one feature point by analyzing the image and may detect the object from the memory 150 based on the feature point.

The processor 160 may verify a location of the electronic device 100. According to at least one example embodiment, the processor 160 may verify a location of the electronic device 100 based on an image captured through the camera 120. Here, the processor 160 may recognize at least one feature point by analyzing the image captured through the camera 120 and may verify a location of the electronic device 100 based on the feature point. For example, the location of the electronic device 100 may include at least one of two-dimensional (2D) coordinates and/or three-dimensional (3D) coordinates. For example, map information may be prestored or stored in the memory 150, and the processor 160 may verify a location of the electronic device 100 from the map information based on a feature point. As another example, map information may be prestored or stored in a server, and the processor 160 may transmit a feature point to the server through the communication device 110 and may receive a location of the electronic device 100 from the server. Here, the server may verify the location of the electronic device 100 from the map information based on the feature point. According to at least one example embodiment, the processor 160 may verify a location of the electronic device 100 based on a signal received from a satellite through the communication device 110. For example, the satellite may include a global positioning system (GPS) satellite. According to at least one example embodiment, the processor 160 may verify a location of the electronic device 100 based on a signal received from a base station through the communication device 110. According to at least one example embodiment, the processor 160 may verify a location of the electronic device 100 based on a signal received from another electronic device through the communication device 110. For example, the signal received from the other electronic device may include at least one of a Wi-Fi protected setup (WPS) signal and/or a beacon signal.

The processor 160 may detect a preset or alternatively, given location in association with at least one of the object and/or the image. Here, the processor 160 may detect the preset or alternatively, given location based on the location of the electronic device 100. According to at least one example embodiment, the preset or alternatively, given location may be present within a preset or alternatively, given radius from a location of the electronic device 100 as an area that belongs to an image captured through the camera 120. According to at least one example embodiment, the preset or alternatively, given location may be present outside the preset or alternatively, given radius from the location of the electronic device 100 as an area that does not belong to the image captured through the camera 120. For example, the preset or alternatively, given location may be mapped to at least one of the object and/or the location of the electronic device 100, and thereby prestored or stored in the memory 150.

The processor 160 may output augmentation content based on at least one of the object and/or the preset or alternatively, given location. Here, the processor 160 may output the augmentation content while displaying the image captured through the camera 120. According to at least one example embodiment, the processor 160 may output the augmentation content while displaying the image through the output device 140. According to at least one example embodiment, the processor 160 may generate an augmented reality image including the image captured through the camera 120 and the augmentation content. The augmentation content may be overlaid on the image captured through the camera 120 in the augmented reality image. The image captured through the camera 120 may be an image, a video, a video frame, a video stream, etc. According to at least one example embodiment, references herein to outputting augmentation content refer to outputting the augmented reality image to a display device. Outputting the augmented reality image may include continuously outputting the augmented reality image (e.g., as a video, stream, etc.) and updating the augmented reality image based on, e.g., obtaining an updated image captured through the camera 120, modifying the augmentation content, etc. According to at least one example embodiment, the processor 160 may output the augmentation content while displaying the image through the external device 181, 183. For example, the external device 181, 183 may be wearable on a face of the user. For example, the external device 181, 183 may be a head mount display (HMD) device and/or an AR glass. Here, the augmentation content may include at least one of first augmentation content corresponding to the object and/or second augmentation content corresponding to the preset or alternatively, given location. For example, the first augmentation content may be mapped to the object and thereby prestored or stored in the memory 150, and the second augmentation content may be mapped to the preset or alternatively, given location and thereby prestored or stored in the memory 150.

The processor 160 may output the first augmentation content in correspondence to the object. According to at least one example embodiment, outputting the first augmentation content in correspondence to the object may refer to outputting the first augmentation content at a location corresponding to the location of the object (e.g., at or near a location of at least a portion of the object). According to at least one example embodiment, the processor 160 may determine the first augmentation content based on the object. According to at least one example embodiment, the processor 160 may determine the first augmentation content based on the object and may modify the first augmentation content based on the preset or alternatively, given location. For example, referring to FIG. 2A, if a distance between an object 210 and a preset or alternatively, given location exceeds a preset or alternatively, given distance, the processor 160 may determine first augmentation content 220 and may output the first augmentation content 220 in correspondence to the object 210 in an image 200. Referring to FIG. 2B and/or 2C, if the distance between the object 210 and the preset or alternatively, given location is less than or equal to the preset or alternatively, given distance, the processor 160 may modify (e.g., first modify) the first augmentation content 220 and may output the first modified first augmentation content 230 in correspondence to the object 210 in the image 200. Referring to FIG. 2C, the processor 160 may further output additional content 240, for example, a travel route from a location of the electronic device 100 to the preset or alternatively, given location with the image 200. If the preset or alternatively, given location is an area that belongs to (e.g., is included in) an image captured through the camera 120, the processor 160 may output second augmentation content in correspondence to the preset or alternatively, given location. According to at least one example embodiment, outputting the second augmentation content in correspondence to the preset or alternatively, given location may refer to outputting the first augmentation content at a location corresponding to the preset or alternatively, given location (e.g., at or near the preset or alternatively, given location). To this end, the processor 160 may determine the second augmentation content based on the preset or alternatively, given location. Here, if the second augmentation content is determined and the preset or alternatively, given location is an area that does not belong to the image captured through the camera 120, the processor 160 may not output the second augmentation content.

The processor 160 may modify the augmentation content based on a movement of the augmentation content (e.g., movement of the object and/or the electronic device 100). Here, the processor 160 may modify the augmentation content based on at least one of a distance between the augmentation content (e.g., the object and/or the electronic device 100) and the preset or alternatively, given location, and/or a duration time of the distance (e.g., a duration during which the distance is greater or less than a threshold distance). Here, the processor 160 may modify the first augmentation content based on a movement of the first augmentation content. For example, the processor 160 may verify a movement of the object and may move the first augmentation content along the object. As another example, the processor 160 may move the first augmentation content regardless of a movement of the object, through an interface with the user using the input device 130. For example, while outputting the first augmentation content 220, 230 (e.g., the first augmentation content 220 and/or the first modified first augmentation content 230) as shown in FIG. 2A, 2B, or 2C, the processor 160 may modify (e.g., second modify) the first augmentation content 220, 230 and may output the second modified first augmentation content 250 in correspondence to the object 210 in the image 200 as shown in FIG. 2D, 2E, and/or 2F. If a distance between the first augmentation content 220, 230 (e.g., the object and/or the electronic device 100) and the preset or alternatively, given location reaches (e.g., is within) a preset or alternatively, given threshold, or if a preset or alternatively, given duration of time is maintained with the distance reaching the threshold, the processor 160 may second modify the first augmentation content 220, 230. Here, until the distance between the first augmentation content 220, 230 and the preset or alternatively, given location reaches the preset or alternatively, given threshold, the processor 160 may sequentially second modify the first augmentation content 220, 230 at preset or alternatively, given intervals. For example, referring to FIG. 2E, the processor 160 may additionally update the additional content 240. As another example, referring to FIG. 2F, since the preset or alternatively, given location belongs to an image captured through the camera 120, the processor 160 may further output second augmentation content 260 in correspondence to the preset or alternatively, given location in the image 200. 2F.

The electronic device 100 according to at least one example embodiment may include the memory 150 and the processor 160 configured to connect to the memory 150 and configured to execute at least one instruction stored in the memory 150.

According to at least one example embodiment, the processor 160 may be configured to recognize an object based on an image being captured, detect a preset or alternatively, given location in association with at least one of the object and/or the image, determine augmentation content based on the object and the preset or alternatively, given location, and output augmentation content in correspondence to the object while displaying the image.

According to at least one example embodiment, the processor 160 may be configured to modify the augmentation content based on a movement of the augmentation content.

According to at least one example embodiment, the processor 160 may be configured to modify the augmentation content based on at least one of a distance between the augmentation content and the preset or alternatively, given location and/or a duration time of the distance (e.g., a duration during which the distance is greater or less than a threshold distance).

According to at least one example embodiment, the processor 160 may be configured to move the augmentation content along the object in response to a movement of the object or move the augmentation content through (e.g., based on or in response to an input received via) an interface with a user.

According to at least one example embodiment, the processor 160 may be configured to determine first augmentation content based on the object, modify the first augmentation content based on a distance between the object and the preset or alternatively, given location, and output the augmentation content in correspondence to the object while displaying the image.

According to at least one example embodiment, the processor 160 may be configured to determine second augmentation content based on the preset or alternatively, given location.

According to at least one example embodiment, the processor 160 may be configured to output the first augmentation content in correspondence to the object and output the second augmentation content in correspondence to the preset or alternatively, given location.

According to at least one example embodiment, the processor 160 may be configured to detect the preset or alternatively, given location in association with at least one of the object and/or the image, based on the location of the electronic device 100.

According to at least one example embodiment, the processor 160 may be configured to verify a location of the electronic device 100 by analyzing the image or verify the location of the electronic device 100 through communication with the external device 181.

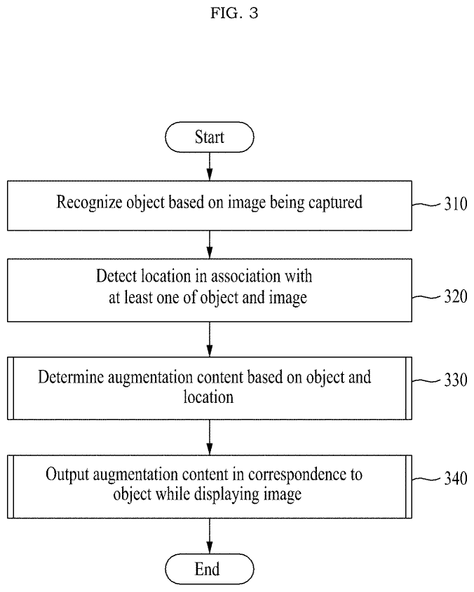

FIG. 3 is a flowchart illustrating an example of an operating method of the electronic device 100 according to at least one example embodiment.

Referring to FIG. 3, in operation 310, the electronic device 100 may recognize an object based on an image being captured. The processor 160 may recognize the object based on the image captured through the camera 120. According to at least one example embodiment, the object may be fixed at a preset or alternatively, given location and/or may be moved to another location by an administrator. According to at least one example embodiment, the object may be carried and/or moved by the user of the electronic device 100. According to at least one example embodiment, the object may be moved through autonomous driving. For example, information about at least one object may be prestored or stored in the memory 150. The processor 160 may recognize at least one feature point by analyzing the image and may detect the object from the memory 150 based on the feature point.

In operation 320, the electronic device 100 may detect a preset or alternatively, given location in association with at least one of the object and/or the image. The processor 160 may verify a location of the electronic device 100. According to at least one example embodiment, the processor 160 may verify a location of the electronic device 100 based on an image captured through the camera 120. Here, the processor 160 may recognize at least one feature point by analyzing the image captured through the camera 120 and may verify the location of the electronic device 100 based on the feature point. For example, map information may be prestored or stored in the memory 150 and the processor 160 may verify a location of the electronic device 100 from the map information based on a feature point. As another example, map information may be prestored or stored in a server, and the processor 160 may transmit a feature point to the server through the communication device 110 and may receive a location of the electronic device 100 from the server. Here, the server may verify the location of the electronic device 100 from the map information based on the feature point. According to at least one example embodiment, the processor 160 may verify a location of the electronic device 100 based on a signal received from a satellite through the communication device 110. According to at least one example embodiment, the processor 160 may verify a location of the electronic device 100 based on a signal received from a base station through the communication device 110. Through this, the processor 160 may detect the preset or alternatively, given location based on the location of the electronic device 100. According to at least one example embodiment, the preset or alternatively, given location may be present within a preset or alternatively, given radius from a location of the electronic device 100 as an area that belongs to an image captured through the camera 120. According to at least one example embodiment, the preset or alternatively, given location may be present outside the preset or alternatively, given radius from the location of the electronic device 100 as an area that does not belong to the image captured through the camera 120. For example, the preset or alternatively, given location may be mapped to at least one of the object and/or the location of the electronic device 100, and thereby prestored or stored in the memory 150.

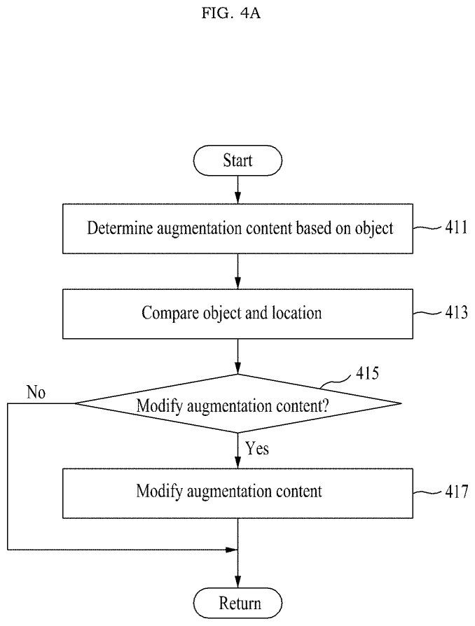

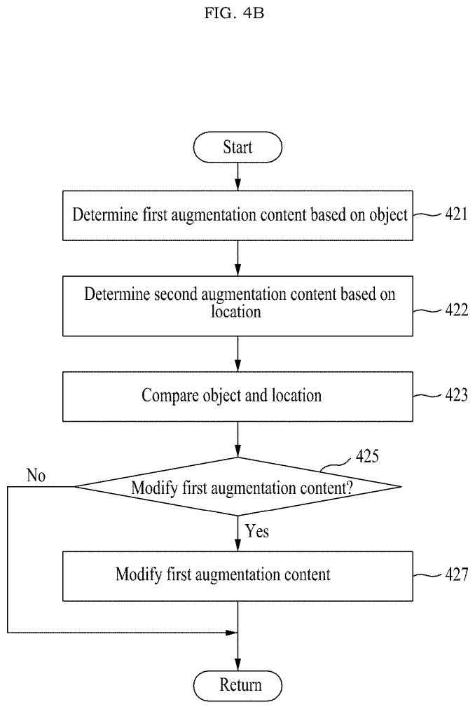

In operation 330, the electronic device 100 may determine augmentation content based on the object and/or the preset or alternatively, given location. The augmentation content may include at least one of first augmentation content corresponding to the object, and/or second augmentation content corresponding to the preset or alternatively, given location. According to at least one example embodiment, the processor 160 may determine the first augmentation content based on the object and the preset or alternatively, given location. Further description related thereto is made with reference to FIG. 4A. According to at least one example embodiment, the processor 160 may determine the first augmentation content and the second augmentation content based on the object and the preset or alternatively, given location, respectively. Further description related thereto is made with reference to FIG. 4B.

FIG. 4A is a flowchart illustrating an example of an augmentation content determining operation 330 of the electronic device 100 according to at least one example embodiment.

Referring to FIG. 4A, in operation 411, the electronic device 100 may determine the first augmentation content based on the object. The processor 160 may determine the first augmentation content mapped to the object. For example, the first augmentation content may be mapped to the object, and thereby prestored or stored in the memory 150 as information about the object.

In operation 413, the electronic device 100 may compare the object to the preset or alternatively, given location. The processor 160 may calculate a distance between the object and the preset or alternatively, given location. Through this (e.g., based on the calculated distance), in operation 415, the electronic device 100 may determine whether to modify the first augmentation content. The processor 160 may compare the distance between the object and the preset or alternatively, given location to a preset or alternatively, given distance. Here, if the distance between the object and the preset or alternatively, given location exceeds the preset or alternatively, given distance, the processor 160 may determine that the first augmentation content should not be modified. In contrast, if the distance between the object and the preset or alternatively, given location is less than or equal to the preset or alternatively, given distance, the processor 160 may determine that the first augmentation content should be modified.

When it is determined that the first augmentation content should not to be modified in operation 415, the electronic device 100 may proceed with operation 340 discussed in association with FIG. 3. When it is determined that the first augmentation content should be modified in operation 415, the electronic device 100 may modify the first augmentation content in operation 417. Next, the electronic device 100 may proceed with operation 340 discussed in association with FIG. 3.

FIG. 4B is a flowchart illustrating another example of an augmentation content determining operation 330 of the electronic device 100 according to at least one example embodiment.

Referring to FIG. 4B, in operation 421, the electronic device 100 may determine the first augmentation content based on the object. The processor 160 may determine the first augmentation content mapped to the object. For example, the first augmentation content may be mapped to the object, and thereby prestored or stored in the memory 150 as information about the object.

In operation 422, the electronic device 100 may determine the second augmentation content based on the preset or alternatively, given location. The processor 160 may determine the second augmentation content mapped to the preset or alternatively, given location. For example, the second augmentation content may be mapped to the preset or alternatively, given location, and thereby prestored or stored in the memory 150 as map information.

In operation 423, the electronic device 100 may compare the object to the preset or alternatively, given location. The processor 160 may calculate a distance between the object and the preset or alternatively, given location. Through this (e.g., based on the calculated distance), in operation 425, the electronic device 100 may determine whether to modify the first augmentation content. The processor 160 may compare the distance between the object and the preset or alternatively, given location to the preset or alternatively, given distance. Here, if the distance between the object and the preset or alternatively, given location exceeds the preset or alternatively, given distance, the processor 160 may determine that the first augmentation content should not be modified. In contrast, if the distance between the object and the preset or alternatively, given location is less than or equal to the preset or alternatively, given distance, the processor 160 may determine that the first augmentation content should be modified.

When it is determined that the first augmentation content should not be modified in operation 425, the electronic device 100 may proceed with operation 340 discussed in association with FIG. 3. When it is determined that the first augmentation content should be modified in operation 425, the electronic device 100 may modify the first augmentation content in operation 427. Next, the electronic device 100 may proceed with operation 340 discussed in association with FIG. 3.

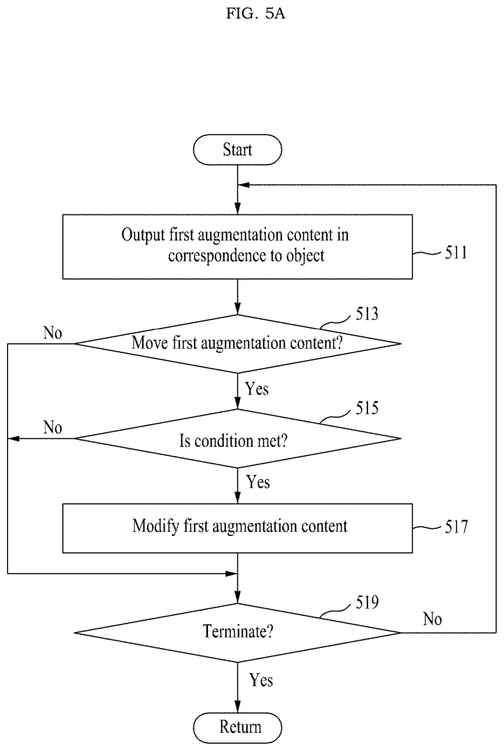

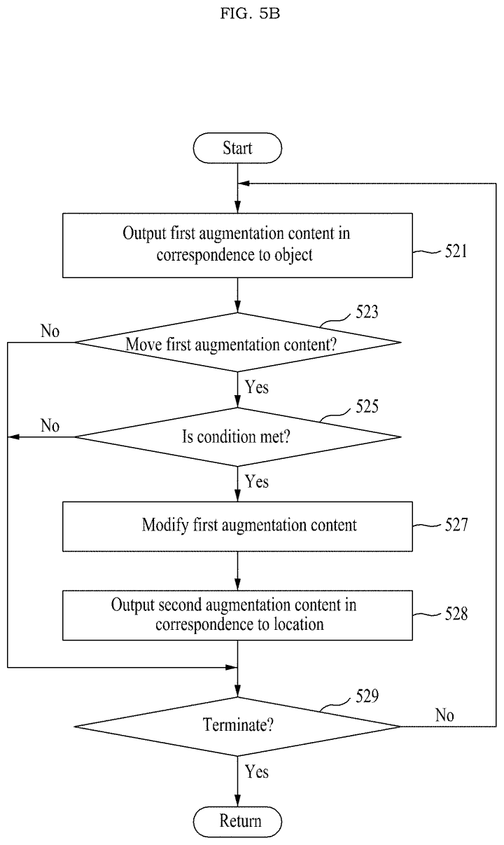

Referring again to FIG. 3, in operation 340, the electronic device 100 may output the augmentation content in correspondence to the object while displaying the image. The processor 160 may output the augmentation content while displaying the image captured through the camera 120. According to at least one example embodiment, the processor 160 may generate an augmented reality image including the image captured through the camera 120 and the augmentation content. The augmentation content may be overlaid on the image captured through the camera 120 in the augmented reality image. The image captured through the camera 120 may be an image, a video, a video frame, a video stream, etc. According to at least one example embodiment, references herein to outputting augmentation content refer to outputting the augmented reality image to a display device. Outputting the augmented reality image may include continuously outputting the augmented reality image (e.g., as a video, stream, etc.) and updating the augmented reality image based on, e.g., obtaining an updated image captured through the camera 120, modifying the augmentation content, etc. Here, the processor 160 may modify the augmentation content based on a movement of the augmentation content. The processor 160 may modify the augmentation content based on at least one of a distance between the augmentation content and the preset or alternatively, given location, and/or a duration time of the distance (e.g., a duration during which the distance is greater or less than a threshold distance). According to at least one example embodiment, the processor 160 may output the first augmentation content in correspondence to the object. According to at least one example embodiment, outputting the first augmentation content in correspondence to the object may refer to outputting the first augmentation content at a location corresponding to the location of the object (e.g., at or near a location of at least a portion of the object). Here, the processor 160 may modify the first augmentation content based on a movement of the first augmentation content. Further description related thereto is made with reference to FIG. 5A. According to at least one example embodiment, the processor 160 may output the first augmentation content in correspondence to the object, and may output the second augmentation content in correspondence to the preset or alternatively, given location. Here, the processor 160 may modify the first augmentation content based on a movement of the first augmentation content. Further description related thereto is made with reference to FIG. 5B.

FIG. 5A is a flowchart illustrating an example of an augmentation content outputting operation 340 of the electronic device 100 according to at least one example embodiment. Hereinafter, the augmentation content outputting operation is described with reference to FIG. 5A and FIGS. 2A to 2E.

Referring to FIG. 5A, in operation 511, the electronic device 100 may output the first augmentation content 220, 230 in correspondence to the object 210. Here, the processor 160 may output the first augmentation content 220, 230 in correspondence to the object 210 while displaying the image 200. For example, the processor 160 may output the first augmentation content 220, 230 as shown in FIG. 2A, 2B, or 2C. If a distance between the object 210 and the preset or alternatively, given location exceeds a preset or alternatively, given distance, the processor 160 may output the first augmentation content 220 in correspondence to the object 210 in the image 200 as shown in FIG. 2A. In contrast, if the distance between the object 210 and the preset or alternatively, given distance is less than or equal to the preset or alternatively, given distance, the processor 160 may output the modified first augmentation content 230 in correspondence to the object 210 in the image 200 as shown in FIG. 2B or 2C. For example, as shown in FIG. 2C, the processor 160 may further output the additional content 240 for guiding a travel route from a location of the electronic device 100 to the preset or alternatively, given location with the image 200. Here, the processor 160 may determine a location of the first augmentation content 220, 230 in correspondence to the object 210.

In operation 513, the electronic device 100 may verify a movement of the first augmentation content 220, 230. The processor 160 may verify the movement of the first augmentation content 220, 230. The processor 160 may verify a movement of the object 210 and may move the first augmentation content 220, 230 along the object 210. According to at least one example embodiment, the object 210 may be moved by an administrator. According to at least one example embodiment, the object 210 may be carried and/or moved by the user of the electronic device 100. According to at least one example embodiment, the object 210 may be moved through autonomous driving. Here, the processor 160 may verify the movement of the object 210 from the image 200 captured through the camera 120. The processor 160 may move the first augmentation content 220, 230 along the object 210. Regardless of the movement of the object 210, the processor 160 may move the first augmentation content 220, 230 through (e.g., based on a command received via) an interface with the user using the input device 130. Through this, the processor 160 may update a location of the first augmentation content 220, 230.

In operation 515, the electronic device 100 may determine whether a preset or alternatively, given condition is met based on the movement of the first augmentation content 220, 230. Here, the condition may be preset or alternatively, given based on at least one of a distance between the first augmentation content 220, 230 and the preset or alternatively, given location, and/or a duration time of the distance (e.g., a duration during which the distance is greater or less than a threshold distance). The processor 160 may calculate the distance between the first augmentation content 220, 230 (e.g., the object and/or the electronic device 100) and the preset or alternatively, given location. The processor 160 may determine whether the distance between the first augmentation content 220, 230 and the preset or alternatively, given location is less than or equal to a preset or alternatively, given threshold. According to at least one example embodiment, if the distance between the first augmentation content 220, 230 and the preset or alternatively, given location is less than or equal to the preset or alternatively, given threshold, the processor 160 may determine that the corresponding condition is met. In contrast, if the distance between the first augmentation content 220, 230 and the preset or alternatively, given location exceeds the preset or alternatively, given threshold, the processor 160 may determine that the corresponding condition is not met. According to at least one example embodiment, if the distance between the first augmentation content 220, 230 and the preset or alternatively, given location is less than or equal to the preset or alternatively, given threshold, the processor 160 may measure the duration time of the distance (e.g., a duration during which the distance is greater or less than a threshold distance). If the distance is maintained during a preset or alternatively, given period of time, the processor 160 may determine that the corresponding condition is met. In contrast, if the distance is not maintained during the preset or alternatively, given period of time, the processor 160 may determine that the corresponding condition is not met.

When it is determined that the preset or alternatively, given condition is met in operation 515, the electronic device 100 may modify (e.g., second modify) the first augmentation content 220, 230 in operation 517. The processor 160 may second modify the first augmentation content 220, 230 based on the movement of the first augmentation content 220, 230. For example, referring to FIG. 2D or 2E, the processor 160 may second modify the first augmentation content 220, 230 and may output the second modified first augmentation content 250 in correspondence to the object 210 in the image 200. For example, referring to FIG. 2E, the processor 160 may additionally update the additional content 240.

In operation 519, the electronic device 100 may determine whether to terminate output of the first augmentation content 220, 230, 250 (e.g., the first augmentation content 220, the first modified first augmentation content 230, and/or the second modified first augmentation content 250). For example, if the object 210 disappears from the image 200 captured through the camera 120, the processor 160 may determine that the output of the first augmentation content 220, 230, 250 should be terminated. As another example, the processor 160 may determine that the output of the first augmentation content 220, 230, 250 should be terminated through (e.g., in response to a command received via) the interface with the user using the input device 130.

When it is determined that the output of the first augmentation content 220, 230, 250 should not be terminated in operation 519, the electronic device 100 may return to operation 511. The processor 160 may repeatedly perform at least one of operations 511, 513, 515, 517, and/or 519. Through this, the processor 160 may sequentially modify the second modified first augmentation content 250. For example, the processor 160 may sequentially modify the second modified first augmentation content 250 at preset or alternatively, given intervals until the distance between the first augmentation content 220, 230 and the preset or alternatively, given location reaches the preset or alternatively, given threshold.

In contrast, when it is determined that the output of the first augmentation content 220, 230, 250 should be terminated in operation 519, the electronic device 100 may terminate the output of the first augmentation content 220, 230, 250. For example, the processor 160 may remove the first augmentation content 220, 230, 250 from the image 200 captured through the camera 120. As another example, the processor 160 may not acquire the image 200 through the camera 120.

FIG. 5B is a flowchart illustrating another example of an augmentation content outputting operation 340 of the electronic device 100 according to at least one example embodiment. Hereinafter, the augmentation content outputting operation is described with reference to FIG. 5B and FIGS. 2A to 2F.

Referring to FIG. 5B, in operation 521, the electronic device 100 may output the first augmentation content 220, 230 in correspondence to the object 210. The processor 160 may output the first augmentation content 220, 230 in correspondence to the object 210 while displaying the image 200. For example, the processor 160 may output the first augmentation content 220, 230 as shown in FIG. 2A, 2B, or 2C. If the distance between the object 210 and the preset or alternatively, given location exceeds the preset or alternatively, given distance, the processor 160 may output the first augmentation content 220 in correspondence to the object 210 in the image 200 as shown in FIG. 2A. If the distance between the object 210 and the preset or alternatively, given distance is less than or equal to the preset or alternatively, given distance, the processor 160 may output the first modified first augmentation content 230 in correspondence to the object 210 in the image 200 as shown in FIG. 2B or 2C. For example, as shown in FIG. 2C, the processor 160 may further output the additional content 240 for guiding a travel route from a location of the electronic device 100 to the preset or alternatively, given location with the image 200. Here, the processor 160 may determine a location of the first augmentation content 220, 230 in correspondence to the object 210.

Although not illustrated, the electronic device 100 may further display second augmentation content in correspondence to the preset or alternatively, given location. If the preset or alternatively, given location is an area that belongs to (e.g., is associated with) the image captured through the camera 120, the processor 160 may output the second augmentation content in correspondence to the preset or alternatively, given location. According to at least one example embodiment, outputting the second augmentation content in correspondence to the preset or alternatively, given location may refer to outputting the second augmentation content at a location corresponding to the preset or alternatively, given location (e.g., at or near the preset or alternatively, given location). If the preset or alternatively, given location is an area that does not belong to (e.g., is not associated with) the image captured through the camera 120, the processor 160 may not output the second augmentation content.

In operation 523, the electronic device 100 may verify a movement of the first augmentation content 220, 230. The processor 160 may verify the movement of the first augmentation content 220, 230. The processor 160 may verify a movement of the object 210 and may move the first augmentation content 220, 230 along the object 210. According to at least one example embodiment, the object 210 may be moved by an administrator. According to at least one example embodiment, the object 210 may be carried and/or moved by the user of the electronic device 100. According to at least one example embodiment, the object 210 may be moved through autonomous driving. Here, the processor 160 may verify the movement of the object 210 from the image 200 captured through the camera 120. The processor 160 may move the first augmentation content 220, 230 along the object 210. Regardless of the movement of the object 210, the processor 160 may move the first augmentation content 220, 230 through (e.g., in response to a command received via) the interface with the user using the input device 130. Through this, the processor 160 may update a location of the first augmentation content 220, 230.

In operation 525, the electronic device 100 may determine whether a preset or alternatively, given condition is met based on the movement of the first augmentation content 220, 230. Here, the condition may be predetermined or alternatively, given based on at least one of a distance between the first augmentation content 220, 230 and the preset or alternatively, given location, and/or a duration time of the distance (e.g., a duration during which the distance is greater or less than a threshold distance). The processor 160 may calculate the distance between the first augmentation content 220, 230 and the preset or alternatively, given location. The processor 160 may determine whether the distance between the first augmentation content 220, 230 and the preset or alternatively, given location is less than or equal to a preset or alternatively, given threshold. According to at least one example embodiment, if the distance between the first augmentation content 220, 230 and the preset or alternatively, given location is less than or equal to the preset or alternatively, given threshold, the processor 160 may determine that the corresponding condition is met. In contrast, if the distance between the first augmentation content 220, 230 and the preset or alternatively, given location exceeds the preset or alternatively, given threshold, the processor 160 may determine that the corresponding condition is not met. According to at least one example embodiment, if the distance between the first augmentation content 220, 230 and the preset or alternatively, given location is less than or equal to the preset or alternatively, given threshold, the processor 160 may measure a duration time of the distance (e.g., a duration during which the distance is greater or less than a threshold distance). If the distance is maintained during the preset or alternatively, given period of time, the processor 160 may determine that the corresponding condition is met. In contrast, if the distance is not maintained during the preset or alternatively, given period of time, the processor 160 may determine that the corresponding condition is not met.

When it is determined that the preset or alternatively, given condition is met in operation 525, the electronic device 100 may modify (e.g., second modify) the first augmentation content 220, 230 in operation 527. The processor 160 may modify the first augmentation content 220, 230 based on the movement of the first augmentation content 220, 230. For example, referring to FIG. 2D or 2E, the processor 160 may modify the first augmentation content 220, 230 and may output the second modified first augmentation content 250 in correspondence to the object 210 in the image 200. For example, referring to FIG. 2E, the processor 160 may additionally update the additional content 240.

In operation 528, the electronic device 100 may output the second augmentation content 260 in correspondence to the preset or alternatively, given location. The processor 160 may output the second augmentation content 260 in correspondence to the preset or alternatively, given location while displaying the image 200. For example, referring to FIG. 2F, the processor 160 may output the second augmentation content 260 with the second modified first augmentation content 250. Here, if the second augmentation content 260 is being output, the processor 160 may continuously (e.g., may continue to) output the second augmentation content 260. If the second augmentation content 260 is not output, the processor 160 may additionally output the second augmentation content 260 in the image 200.

In operation 529, the electronic device 100 may determine whether to terminate output of the first augmentation content 220, 230, 250. For example, if the object 210 disappears from the image 200 captured through the camera 120, the processor 160 may determine that the output of the first augmentation content 220, 230, 250 should be terminated. As another example, the processor 160 may determine that the output of the first augmentation content 220, 230, 250 should be terminated through (e.g., in response to a command received via) the interface with the user using the input device 130.

When it is determined that the output of the first augmentation content 220, 230, 250 should not be terminated in operation 529, the electronic device 100 may return to operation 521. The processor 160 may repeatedly perform at least one of operations 521, 523, 525, 527, 528 and/or 529. Through this, the processor 160 may sequentially modify the second modified first augmentation content 250. For example, the processor 160 may sequentially modify the first augmentation content 250 at preset or alternatively, given intervals until the distance between the first augmentation content 220, 230 and the preset or alternatively, given location reaches the preset or alternatively, given threshold.

In contrast, when it is determined that the output of the first augmentation content 220, 230, 250 should be terminated in operation 529, the electronic device 100 may terminate the output of the first augmentation content 220, 230, 250. Here, if the second augmentation content 260 is being displayed, the processor 160 may terminate the output of the second augmentation content 260 with the first augmentation content 220, 230, 250. For example, the processor 160 may remove the first augmentation content 220, 230, 250 and/or the second augmentation content 260 in the image 200 captured through the camera 120. As another example, the processor 160 may not capture the image 200 through the camera 120.

According to at least one example embodiment, the operating method of the electronic device 100 may include recognizing an object based on an image being captured, detecting a preset or alternatively, given location in association with at least one of the object and/or the image, determining augmentation content based on the object and the location, and outputting the augmentation content in correspondence to the object while displaying the image.

According to at least one example embodiment, the operating method of the electronic device 100 may further include modifying the augmentation content based on a movement of the augmentation content.

According to at least one example embodiment, the modifying of the augmentation content may include modifying the augmentation content based on at least one of a distance between the augmentation content and the location, and/or a duration time of the distance.

According to at least one example embodiment, the operating method of the electronic device 100 may further include at least one of moving the augmentation content along the object in response to a movement of the object and/or moving the augmentation content through an interface with a user.

According to at least one example embodiment, the determining of the augmentation content may include determining the first augmentation content based on the object and modifying the first augmentation content based on the preset or alternatively, given location.

According to at least one example embodiment, the modifying of the first augmentation content may include modifying the first augmentation content based on a distance between the object and the preset or alternatively, given location.

According to at least one example embodiment, the determining of the augmentation content may further include second augmentation content based on the preset or alternatively, given location.

According to at least one example embodiment, the outputting of the augmentation content may include outputting the first augmentation content in correspondence to the object, and outputting the second augmentation content in correspondence to the location.

According to at least one example embodiment, the detecting of the location may include verifying a location of the electronic device 100, and detecting the preset or alternatively, given location based on the verified location of the electronic device 100.

According to at least one example embodiment, the verifying of the location of the electronic device 100 may include at least one of verifying the location of the electronic device 100 by analyzing the image, and/or verifying the location of the electronic device 100 through communication with the external device 181.

At least one example embodiment herein may be implemented as a computer program that includes at least one instruction stored in a computer apparatus (e.g., a storage medium readable by the electronic device 100) (e.g., the memory 150). For example, a processor (e.g., the processor 160) of the computer apparatus may call at least one instruction from among the stored one or more instructions from the storage medium and may execute the called at least one instruction, which enables the computer apparatus to operate to perform at least one function according to the called at least one instruction. The at least one instruction may include a code created by a compiler or a code executable by an interpreter. The computer-readable storage medium may be provided in a form of a non-transitory record medium. Here, “non-transitory” simply indicates that the record medium is a tangible device and does not include a signal (e.g., electromagnetic wave). This term does not distinguish a case in which data is semi-permanently stored and a case in which the data is temporarily stored in the record medium.

A computer program according to at least one example embodiment may be configured to perform recognizing an object based on an image being captured, detecting a preset or alternatively, given location in association with at least one of the object and/or the image, determining augmentation content based on the object and the location, and outputting the augmentation content in correspondence to the object while displaying the image.

According to at least one example embodiment, the computer program may be further configured to perform modifying the augmentation content based on a movement of the augmentation content.

According to at least one example embodiment, the electronic device 100 may output augmentation content based on locations of a real environment and an object to provide an augmented reality. Here, since the object has a mobility in the real environment, the electronic device 100 may output the augmentation content in correspondence to the object in various situations, for example, at various locations. The electronic device 100 may determine the augmentation content by associating the object with a preset or alternatively, given location. Here, the electronic device 100 may modify the augmentation content about the object through interaction with a peripheral environment. Through this, the electronic device 100 may appropriately output the augmentation content based on various situations. That is, the electronic device 100 may provide a flexible interface between the electronic device 100 and the user to provide the augmented reality. Accordingly, the electronic device 100 may provide an experience, marketing, and/or a service, further micro-targeted for the user, and interactive with a space and/or a thing, by providing the augmentation content through linkage between locations of the real environment and the object.

For example, the electronic device 100 may provide an AR mask for an object (e.g., a face of a recognized person) as the augmentation content. Here, if the person is present at a specific location, the electronic device 100 may provide an interaction between the augmentation content about the specific location and the augmentation content about the face. For example, the electronic device 100 may output a make-up mask corresponding to the face of the recognized person. In response to the person being located at a cosmetic shop of the specific location, the electronic device 100 may change a lipstick color of the make-up mask with a color preset or alternatively, given for the specific location or may apply, to the make-up mask, an additional make-up function preset or alternatively, given for the specific location.

In the field of augmented reality, it would be desirable to provide augmentation content based on an object and a location of the real environment in order to provide various augmented reality services to a user. For example, providing augmentation content based on such an object and location would enable enhancements to augmented reality applications providing marketing, entertainment, improved user experience, etc. through the linkage of the real environment and the object. Conventional devices and methods provide augmentation content based on only one of an object or a location of the real environment. Accordingly, such conventional devices and methods fail to provide sufficient functionality to enable the linkage of the real environment and the object and, thus, are unable to provide the desirable services described above.

However, according to at least one example embodiment, improved devices and methods are described for providing augmentation content based on both an object and a location of the real environment. For example, the improved devices and methods may provide augmentation content based on the location of the object in the real environment. Accordingly, the improved devices and methods overcome the deficiencies of the conventional devices and methods to provide sufficient functionality to enable the linkage of the real environment and the object and, thus, enable the desirable services described above.

According to at least one example embodiment, operations described herein as being performed by the electronic device 100, the processor 160, the communication device 110, the camera 120, the input device 130, the output device 140, the external device 181 and/or the external device 183 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

At least one example embodiment and the terms used herein are not construed to limit the technique described herein to specific examples and may be understood to include various modifications, equivalents, and/or substitutions. Like reference numerals refer to like elements throughout. As used herein, the singular forms “a,” “an,” and “the,” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe various components and the components should not be limited by the terms. The terms are simply used to distinguish one component from another component. When a component (e.g., a first component) is described to be “(functionally or communicatively) connected to” or “accessed to” another component (e.g., a second component), the component may be directly connected to the other component or may be connected through still another component (e.g., a third component).

The term “module” used herein may include a unit configured as hardware, software, or firmware, and may be interchangeably used with, for example, the terms “logic,” “logic block,” “part,” “circuit,” etc. The module may be an integrally configured part, a minimum unit that performs at least one function, or a portion thereof. For example, the module may be configured as an application-specific integrated circuit (ASIC).

According to at least one example embodiment, each component (e.g., module or program) of the aforementioned components may include a singular entity or a plurality of entities. According to at least one example embodiment, at least one component among the aforementioned components or operations may be omitted, or at least one another component or operation may be added. Alternately or additionally, the plurality of components (e.g., module or program) may be integrated into a single component. In this case, the integrated component may perform the same or a similar functionality as being performed by a corresponding component among a plurality of components before integrating at least one function of each component of the plurality of components. According to at least one example embodiment, operations performed by a module, a program, or another component may be performed in parallel, repeatedly, or heuristically, or at least one of the operations may be performed in a different order or omitted. Alternatively, at least one other operation may be added.

While this disclosure includes at least one example embodiment, it will be apparent to one of ordinary skill in the art that various alterations and modifications in form and details may be made in these examples without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. An operating method of an electronic device, the method comprising:
recognizing an object based on a current image being captured;
detecting a location in association with at least one of the object or the current image;
determining augmentation content based on the object and the location; and
generating an augmented reality image including the current image and the augmentation content in correspondence to the object.

2. The method of claim 1, further comprising:
modifying the augmentation content based on a movement of the object.

3. The method of claim 2, wherein the modifying the augmentation content modifies the augmentation content based on at least one of:
a distance between the object and the location; or
a duration time of the distance.

4. The method of claim 2, further comprising:
moving the augmentation content along the object in response to the movement of the object; or
moving the augmentation content based on a command received via an interface.

5. The method of claim 1, wherein the determining the augmentation content comprises:
determining first augmentation content based on the object; and
modifying the first augmentation content based on the location.

6. The method of claim 5, wherein the modifying the first augmentation content modifies the first augmentation content based on a distance between the object and the location.

7. The method of claim 5, wherein the determining the augmentation content comprises determining second augmentation content based on the location.

8. The method of claim 7, wherein the augmented reality image comprises:
the first augmentation content in correspondence to the object; and
the second augmentation content in correspondence to the location.

9. The method of claim 1, wherein the detecting the location comprises:
verifying a location of the electronic device; and
detecting the location based on the location of the electronic device.

10. The method of claim 9, wherein the verifying comprises:
verifying the location of the electronic device by analyzing the current image; or
verifying the location of the electronic device based on communication with an external device.

11. An electronic device comprising:
processing circuitry configured to cause the electronic device to,
recognize an object based on a current image being captured,
detect a location in association with at least one of the object or the current image,
determine augmentation content based on the object and the location, and
generate an augmented reality image including the current image and the augmentation content in correspondence to the object.

12. The electronic device of claim 11, wherein the processing circuitry is configured to cause the electronic device to modify the augmentation content based on a movement of the object.

13. The electronic device of claim 12, wherein the processing circuitry is configured to cause the electronic device to modify the augmentation content based on at least one of:
a distance between the object and the location; or
a duration time of the distance.

14. The electronic device of claim 11, wherein the processing circuitry is configured to cause the electronic device to detect the location in association with the at least one of the object or the current image based on a location of the electronic device.

15. A non-transitory computer-readable record medium storing instructions that, when executed by processing circuitry, cause the processing circuitry to perform an operating method of an electronic device, the method comprising:
recognizing an object based on a current image being captured;
detecting a location in association with at least one of the object or the current image;
determining augmentation content based on the object and the location; and
generating an augmented reality image including the current image and the augmentation content in correspondence to the object.

16. The non-transitory computer-readable record medium of claim 15, wherein the method further comprises modifying the augmentation content based on a movement of the object.

17. The method of claim 1, further comprising:
outputting the augmented reality image to a display device.

18. The method of claim 8, further comprising:
outputting the augmented reality image to a display device.

19. The electronic device of claim 11, wherein the processing circuitry is configured to cause the electronic device to output the augmented reality image to a display device.

20. The non-transitory computer-readable record medium of claim 15, wherein the method further comprises outputting the augmented reality image to a display device.
